(19) United States
(12) Patent Application Publication
(10) Pub. No.: US 2008/0288565 A1
(43) Pub. Date: Nov. 20, 2008

(54) METHOD TO COMPARE AND SORT BINARY DATA

(75) Inventor: Hung Shih Lin, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/748,650

(22) Filed: May 15, 2007

(51) Int. Cl. G06F 17/00; G06F 7/02; G06F 7/42

(52) U.S. Cl. 708/207; 708/671; 708/700

(57) ABSTRACT

A binary data comparison method is performed as follows. First, bits of a plurality of binary data are provided, and bit x of the plurality of binary data are summed, where x=n, n−1, . . . , 1 or 0, and bit x is the most significant bit (MSB). If the sum is equal to 1, the binary data having bit x=1 is determined as the maximum. If the sum is larger than or equal to 2, the binary data having bit x=0 is masked by setting all bits of the binary data to zero. The above processes are repeated in which bit x is iterated by bit x−1 if the sum is not equal to 1 until the maximum is found.

### BACKGROUND OF THE INVENTION

(A) Field of the Invention

The present invention is related to methods to compare and sort binary data.

(B) Description of the Related Art

A comparator normally compares two or more input values. For instance, if two values A and B are compared, the comparator is configured to acquire the value of “A-B.” If “A-B” is larger than or equal to zero, i.e., a positive value or zero, this indicates A is larger than or equal to B; otherwise, A is smaller than B. The hardware design is simple; it needs only a subtracter associated with some logic elements.

However, if there is a need to determine the maximum of many input values, the traditional methods such as binary tree or a bubbles sort based on the above method need a large amount of computation to obtain the result. Therefore, these traditional methods are not effective for binary data comparison especially for dealing with many binary data.

### SUMMARY OF THE INVENTION

The present invention provides methods to compare and sort binary data, with a view to decreasing the complexity of comparison, and increasing computation speed for dealing with large quantities of binary data. Moreover, the bulkhead area of design is reduced, and the methods are easily implemented for VLSI design.

A binary data comparison method is disclosed in accordance with the present invention. First, bits of a plurality of binary data are provided, and bit x of the plurality of binary data are summed, where x=n, n−1, . . . , 1 or 0, and bit x are most significant bit (MSB). If the sum is equal to 1, the binary data having bit x=1 is determined to be the maximum. If the sum is larger than or equal to 2, the binary data having bit x=0 is masked by setting all bits of the binary data to zero. The above processes are repeated in which bit x is iterated by bit x−1 if the sum is not equal to 1 until the maximum is found.

Such concept can be also employed to find the minimum of a set of binary data. First, complements of the plurality of binary data are determined. Then, the complements undergo the above comparison method to find the maximum one. A binary data corresponding to the maximum complement is determined as the minimum of the plurality of the binary data.

A binary data sorting method is developed based on the binary data comparison method. First, a maximum binary data of a plurality of binary data is found in accordance with the above binary data comparison method. The maximum binary data is determined as the first rank and are masked, i.e. set to zero. The above processes are repeated to determine the maximum binary data as the next rank until all the plurality of binary data are ranked.

### BRIEF DESCRIPTION OF THE DRAWINGS

FIG. 1 illustrates bits of a plurality of binary data in accordance with the embodiments of the present invention;

FIG. 2 illustrates a flow chart of the binary data comparison method in accordance with the embodiments of the present invention; and

FIGS. 3 and 4 illustrate a binary data sorting method in accordance with the embodiments of the present invention.

### DETAILED DESCRIPTION OF THE INVENTION

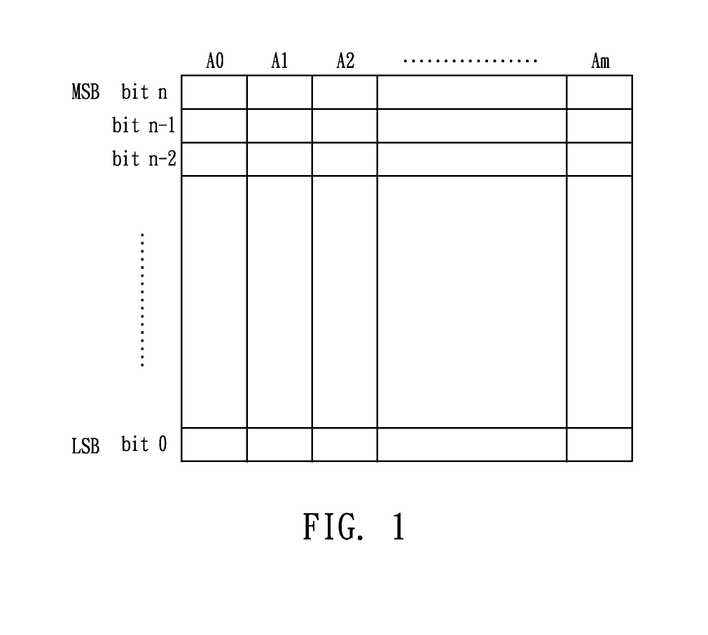

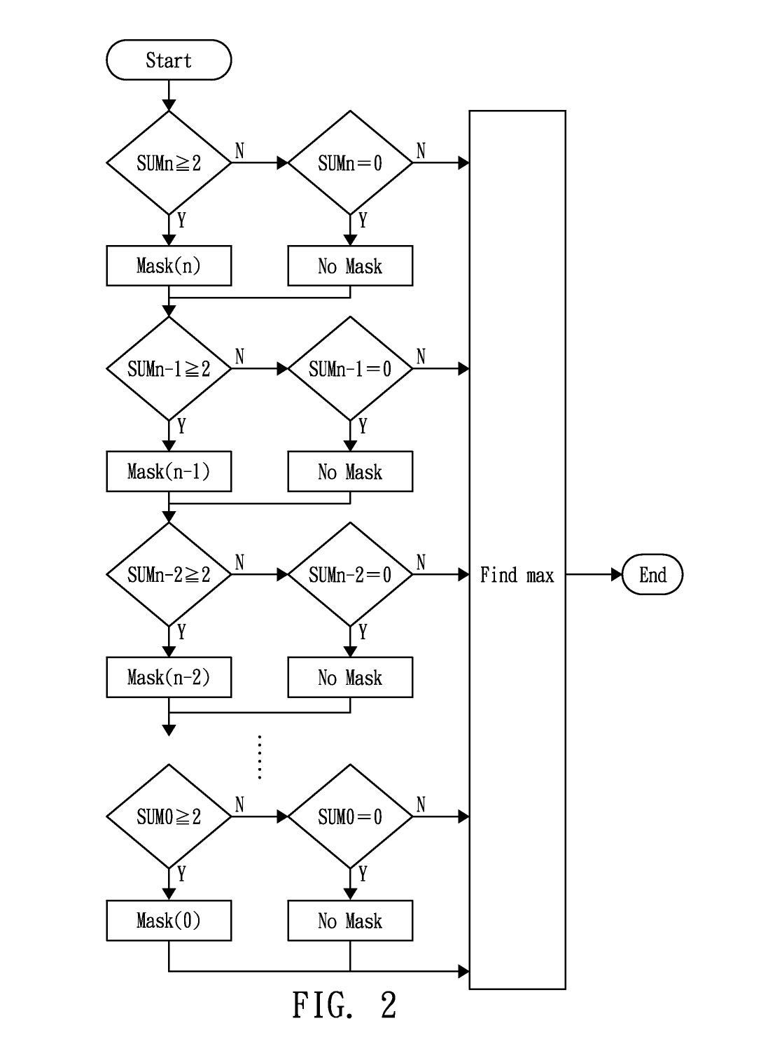

As shown in FIG. 1, bits (from bit 0 to bit n) of each of binary data A0, A1, . . . , Am, which may be stored in registers, are listed, in which bit n is MSB, bit 0 is LSB. The flow chart of comparison of the magnitudes of A0, A1, . . . , Am is shown in FIG. 2.

The bit n of each of A0, A1, . . . , Am are summed as the following equation:

SUM n=A0(bit n)+A1(bit n)+A2(bit n)+ . . . +Am(bit n)

If SUM n≧2, it indicates there are at least two binary data whose bit n is equal to 1. Because bit n is MSB, the maximum binary data must be selected from these two or more binary data. Other binary data are unlikely to be the maximum one, so that the other binary data can be “masked,” i.e., other binary data are not considered in the subsequent maximum binary data finding procedure. The “mask” is operated as follows:

A0=A0(bit n) AND {A0(bit n), A0(bit n−1), . . . , A0(bit 0)}

Accordingly, if A0(bit n)=0, A0 will be reset to be zero. In contrast, if A0(bit n)=1, A0 will not be changed. Consequently, if A0(bit n)=0, A0 will not be considered in the subsequent maximum binary data finding procedure.

If SUM n<2, check whether SUM n=0. If SUM n≠0, SUM n is equal to 1, indicating there is only one binary data having bit n=1, Therefore, the binary data having bit n=1 is the maximum binary data, and the maximum finding process is stopped.

If SUM n=0, indicating the bit n for all binary data are 0. Therefore, there is no information for bit n of the current binary data. Accordingly, the procedure moves to check bit n−1 of the binary data.

Likewise, the bit n−1 of each of A0, A1, . . . , Am are summed as the following equation:

SUM n−1=A0(bit n−1)+A1(bit n−1)+A2(bit n−1)+ . . . +Am(bit n−1),

Then, check whether the SUM n−1=0, 1, or ≧2, and repeat what were processed for SUM n as mentioned above.

Accordingly, the maximum of the binary data will be found after repeating the checking operation for SUM n, SUM n−1, SUM n−2, SUM 0. Note that the process will be stopped if the SUM is equal to 1.

The above description is used for finding the maximum binary data. In practice, a similar procedure also can be implemented for finding the minimum binary data.

First, the plurality of binary data are modified, e.g., undergo 1's complement, to obtain complements of the plurality of binary data. In other words, the bits of the binary data are reversed, i.e., 0 is changed to 1 and 1 is changed to 0, and the complements are negative values of the corresponding binary data. Thereafter, the maximum of the complement is found in accordance with the procedure described above, and the minimum binary data is the one corresponding to the maximum complement.

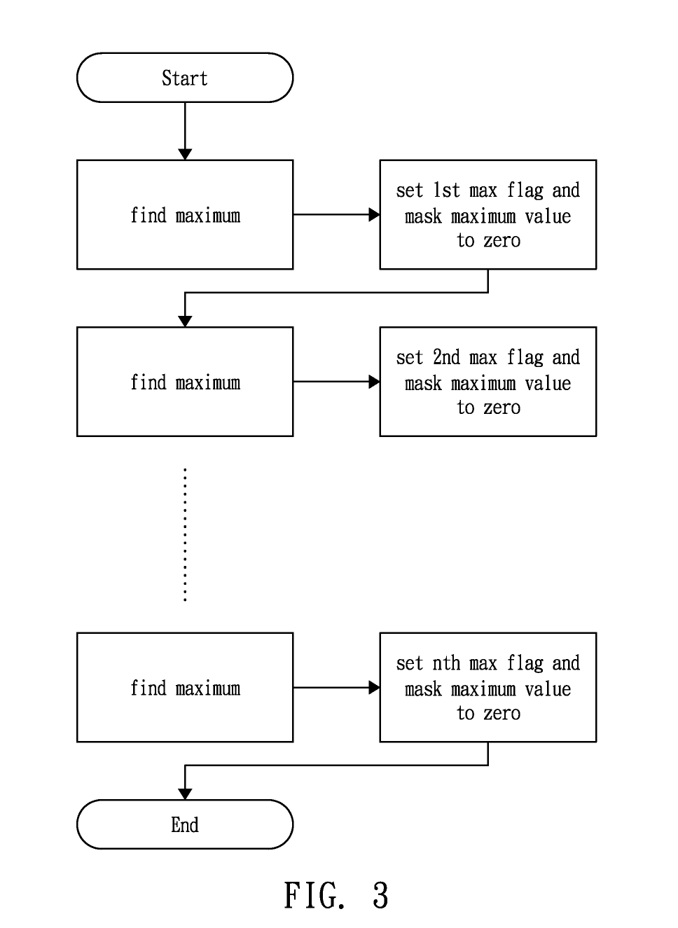

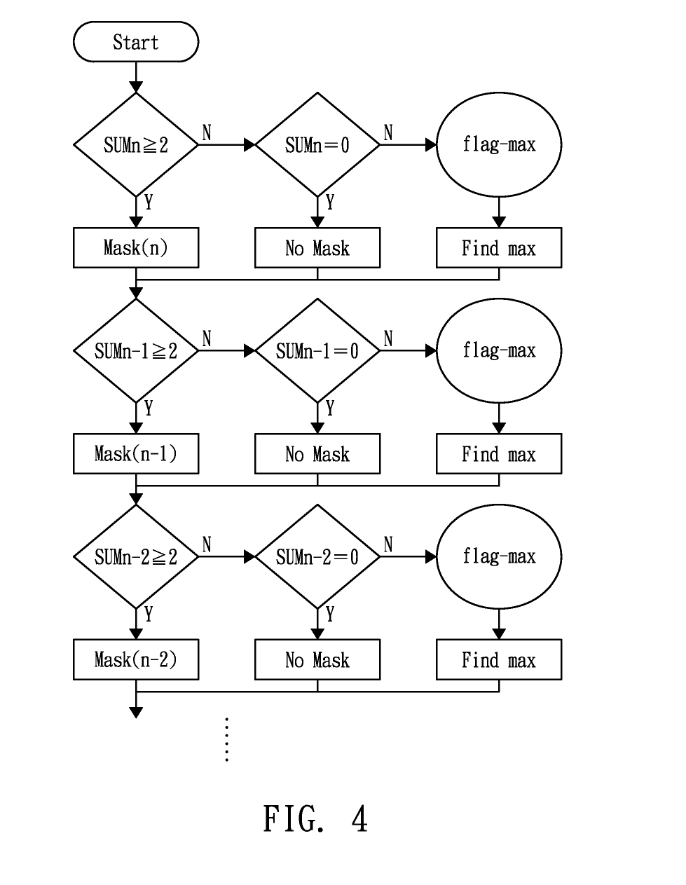

Moreover, the maximum binary data finding process can be associated for sorting the plurality of the binary data. As shown in FIGS. 3 and 4, when the maximum binary data is found in accordance with the above process, marking a first maximum flag thereto, and the maximum binary data is masked, i.e., set to zero, so as to omit the consideration to this maximum binary data afterwards. Accordingly, the maximum binary data is determined as the first rank. The process is repeated to find other maximum binary data, which are marked with second, third, . . . , m-th maximum flags. Accordingly, the plurality of binary data can be sorted based on the sequence of the first, second, . . . , m-th maximum flags. In other words, maximum binary data are found and the second rank, the third rank, the fourth rank . . . are determined until all the plurality of binary data are ranked.

The above-described embodiments of the present invention are intended to be illustratively only. Numerous alternative embodiments may be devised by those skilled in the art without departing from the scope of the following claims.

What is claimed is:

1. A binary data comparison method, comprising the steps of:
(a) providing bits of a plurality of binary data;
(b) summing up bit x of the plurality of binary data, wherein x=n, n−1, . . . , 1 or 0, and bit n is most significant bit (MSB);
(c) determining the binary data having bit x=1 as the maximum if the sum is equal to 1;
(d) masking the binary data having bit x=0 by setting all bits of the binary data to zero if the sum is larger than or equal to 2; and
(e) repeating steps (b) to (d) in which bit x is iterated by bit x=1 if the sum is not equal to 1 until the maximum is found.

2. The binary data comparison method of claim 1, wherein all of bit x are equal to zero if the sum is equal to zero, indicating the maximum cannot be found, and step (e) is performed afterwards.

3. The binary data comparison method of claim 1, wherein one of bit x is equal to 1 if the sum is equal to 1, indicating the maximum is found, and the binary data having bit x=1 is determined as the maximum.

4. The binary data comparison method of claim 1, wherein at least two of bit x are equal to 1 if the sum is equal to or larger than 2, indicating the maximum cannot be found, and all bits of the binary data having bit x=are set to zero, then step (e) is performed.

5. A binary data comparison method, comprising the steps of:
(a) providing bits of a plurality of binary data;
(b) determining complements of the plurality of binary data;
(c) summing up bit x of the complements, wherein x=n, n−1, . . . , 1 or 0, and bit x is most significant bit (MSB);
(d) determining the complement having bit x=1 as the maximum if the sum is equal to 1;
(e) masking the complements having bit x=0 by setting all bits of the complement to zero if the sum is larger than or equal to 2;
(f) repeating steps (c) to (e) in which bit x is iterated by bit x−1 if the sum is not equal to 1 until the maximum is found; and
(g) determining a binary data corresponding to the maximum complement as the minimum of the plurality of the binary data.

6. The binary data comparison method of claim 5, wherein all of bit x are equal to zero if the sum is equal to zero, indicating the maximum cannot be found, and step (f) is performed afterwards.

7. The binary data comparison method of claim 5, wherein one of bit x is equal to 1 if the sum is equal to 1, indicating the maximum is found, and the binary data having bit x=1 is determined as the maximum.

8. The binary data comparison method of claim 5, wherein at least two of bit x are equal to 1 if the sum is equal to or larger than 2, indicating the maximum cannot be found, and all bits of the binary data having bit x=are set to zero, then step (f) is performed.

9. A binary data sorting method, comprising the steps of:
(a) finding a maximum binary data of a plurality of binary data;
(b) determining the maximum binary data as a rank, and masking the maximum binary data; and
(c) repeating steps (a) and (b) to determine the maximum binary data as the next rank until all the plurality of binary data are ranked.

10. The binary data sorting method of claim 9, wherein the step of finding a maximum binary data of a plurality of binary data is according to the binary data comparison method of claim 1.
